(19) United States
(12) Patent Application Publication
(10) Pub. No.: US 2006/0223438 A1
(43) Pub. Date: Oct. 5, 2006

(54) Multi purpose standardized telecommunications network

(76) Inventor: Hassan Behbehani, Kuwait (KW)

Correspondence Address: Hassan Behbehani, P.O. Box: 1262, Safat, Kuwait, 13013, KW

(21) Appl. No.: 11/097,321

(22) Filed: Apr. 4, 2005

(51) Int. Cl. H04H 7/00

(52) U.S. Cl. 455/3.06

(57) ABSTRACT

Because of the pervasive nature of information and communication technologies and the services that derive from them, coupled with the large prizes to be won, the telecommunications sector is subjected to a lot of attention. In this era, technology has gone to endless limits. Room sized computers are coming into devices that can be taken in a palm, phones are using satellites and have implications more than conversation without using any physical medium and business and daily life has become technology enabled. Mobile phone can be said as gift of technology without any doubts. The presented invention is also related with mobile phones. The invention connects the mobile phone and multimedia and makes the life of people easy. The invention also help TV channels, Telecommunication companies and Advertisement companies to do targeted advertisement according to selected people, selected areas, selected countries and selected regions.

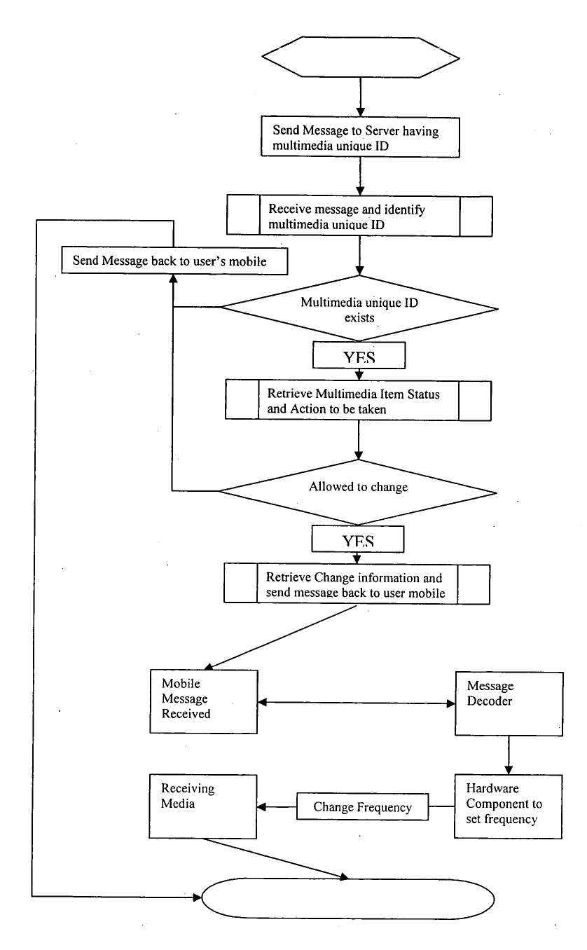

### BACKGROUND OF THE INVENTION

Due to the invasive nature of information and communication technologies and the services that derive from them the telecommunications sector is attracting attention of big players including governments, financial and investment institutions. While traditional telecommunications networks have allowed us to cross barriers associated with time and distance, the new multimedia realm is allowing us to include vital physical cues in the information stream, introducing a physical reality into the world of electronic communications, goods, and services. Not surprisingly, some of the industries that are being most radically revolutionized are those that deal with the human senses, including entertainment, health care, education, advertising, and, sadly, warfare. Simply put, technology changes your way and pace of life.

In recent years, the word telecommunications has been used so often, and applied in so many situations, that it has become part of our daily lexicon, yet its definition remains elusive. So, let's start with a definition. The word telecommunications has its roots in Greek: tele means “over a distance,” and communicara means “the ability to share.” Hence, telecommunications literally means “the sharing of information over a distance.” Telecommunications is more than a set of technologies, it's more than an enormous global industry (estimated to be US$2.5 trillion), it's more than twenty-first-century business and law that is being re-created to accommodate a virtual world, and it's more than a creator and destroyer of the state of the economy. Telecommunications is a way of life. Telecommunications affects how and where you do everything—live, work, play, socialize, entertain, serve, study, teach, rest, heal, and protect. Telecommunications has served a critical role in shaping society and culture, as well as in shaping business and economics.

It is important to examine telecommunications from the broadest perspective possible to truly appreciate the depth and complexity of this field and thereby understand the opportunities it affords. The best way to learn to “think telecom” is to quickly examine how it is changing both business and lifestyle.

Throughout the 1980s and 1990s, much of the IT&T (information technologies and telecommunications) industry's focus was on how to reengineer the likes of financial institutions, manufacturing, retail, service, and government. These technology deployments were largely pursued and justified on the grounds of reducing costs and enhancing competitiveness by speeding communications. Today, we are shifting our focus to another set of objectives: Our technology deployments are targeted at supporting not just the needs of a business enterprise, but also those of the consumers.

The revolution in integrated media is transforming all aspects of human activity related to communication and information. We are moving to computer-based environments that support the creation, sharing, and distribution of multimodal information. Whereas traditional telecommunications networks have allowed us to cross barriers associated with time and distance, the new multimedia realm is allowing us to include vital physical cues in the information stream, introducing a physical reality into the world of electronic communications, goods, and services.

Not surprisingly, some of the industries that are being most radically revolutionized are those that deal with the human senses, including entertainment, health care, education, advertising, and, sadly, warfare. In each of these key sectors, there are telecommunications solutions that address the business need, reduce costs, or enhance operations by speeding business processes and aiding communications. These industries are also examining how to virtualize their products and/or services—that is, how to apply telecommunications to support electronic services targeted at the consumers of that industry's products. Not surprisingly, changing the way you attend a class, see a doctor, watch a movie, get a date, shop for software, take a cruise, and stay in touch creates significant changes in how you use your time and money. Simply put, technology changes your way and pace of life.

A quick orientation of how emerging technologies are affecting industries and lifestyle highlights the importance of understanding the principles of telecommunications, and, hopefully, to inspire you to “think telecom.” The changes discussed here are ultimately very important to how telecommunications networks will evolve and to where the growth areas will be.

An enormous amount of the activity driving telecommunications has to do with the emergence of advanced applications; likewise, advances in telecommunications capabilities spur developments in computing platforms and capabilities. The two are intimately and forever intertwined. The following sections discuss some of the changes that are occurring in both telecommunications and in computing platforms and applications, as well as some of the changes expected in the next several years.

Telecommunications has allowed a virtual world to emerge—one in which time and distance no longer represent a barrier to doing business or communicating—but we're still lacking something that is a critical part of the human information-processing realm. The human mind acts on physical sensations in the course of its information processing; the senses of sight, sound, touch, and motion are key to our perception and decision making. Developments in sensory technologies and networks will allow a new genre of sensory reality to emerge, bridging the gap between humans and machines. One of the most significant evolutions occurring in computing and communications is the introduction of the human senses into electronic information streams.

The following are a few of the key developments in support of this more intuitive collaborative human-machine environment:
Computers are now capable of hearing and speaking, as demonstrated by Tellme, a popular U.S. voice-activated service that responds to defined voice prompts and provides free stock quotes, weather information, and entertainment guides to 35,000 U.S. cities.
The capability to produce three-dimensional sound through digital mastery—a technology called “virtual miking”—is being developed at the University of Southern California's Integrated Media Systems Center.
Virtual touch, or haptics, enables a user to reach in and physically interact with simulated computer content, such as feeling the weight of the Hope diamond in your hand or feeling the fur of a lion. Two companies producing technology in this area are SensAble Technologies and Immersion Corporation. They are producing state-of-the-art force feedback, whole-hand sensing, and real-time 3D interaction technologies, and these hardware and software products have a wide range of applications for the manufacturing and consumer markets, including virtual-reality job training, computer-aided design, remote handling of hazardous materials, and “touch” museums.
The seduction of smell is also beginning to find its way into computers, allowing marketers to capitalize on the many subtle psychological states that smell can induce. Studies show that aromas can be used to trigger fear, excitement, and many other emotions. Smell can be used to attract visitors to Web sites, to make them linger longer and buy more, to help them assimilate and retain information, or to instill the most satisfying or terrifying of emotional states (now that's an interactive game!). Three companies providing this technology today are Aromajet, DigiScents, and TriSenx. Aromajet, for example, creates products that address video games, entertainment, medical, market research, personal and home products, and marketing and point of sales applications.
The visual information stream provides the most rapid infusion of information, and a large portion of the human brain is devoted to processing visual information. To help humans process visual information, computers today can see; equipped with video cameras, computers can capture and send images, and can display high-quality entertainment programming. The visual stream is incredibly demanding in terms of network performance; thus, networks today are rapidly preparing to enable this most meaningful of information streams to be easily distributed.

How we engage in computing and communications will change dramatically in the next decade. Portable computing devices have changed our notion of what and where a workplace is and emphasized our desire for mobility and wireless communication; they are beginning to redefine the phrase dressed for success. But the portable devices we know today are just a stepping stone on the way to wearables. Context-aware wearable computing will be the ultimate in light, ergonomic, reliable, flexible, and scalable platforms. Products that are available for use in industrial environments today will soon lead to inexpensive, easy-to-use wearables appearing at your neighborhood electronics store:
Xybernaut's Mobile Assistant IV (MA-IV), a wearable computer, provides its wearer with a full-fledged PC that has a 233 MHz Pentium chip, 32 MB memory, and upward of 3 GB storage. A wrist keyboard sports 60 keys. Headgear suspended in front of the eye provides a full-color VGA screen, the size of a postage stamp but so close to the eye that images appear as on a 15-inch monitor. A miniature video camera fits snugly in a shirt pocket. Bell Canada workers use MA-IVs in the field; they replace the need to carry manuals and provide the ability to send images and video back to confer with supervisors. The MA-IV is rather bulky, weighing in at 4.4 pounds (2 kilograms), but the soon-to-be-released MA-V will be the first mass-market version, and it promises to be lightweight.

MIThril is the next-generation wearables research platform currently in development at MIT's Media Lab. It is a functional, operational body-worn computing architecture for context-aware human-computer interaction research and general-purpose wearable computing applications. The MIThril architecture combines a multiprotocol body bus and body network, integrating a range of sensors, interfaces, and computing cores. It is designed to be integrated into everyday clothing, and it is both ergonomic and flexible. It combines small, light-weight RISC processors (including the StrongARM), a single-cable power/data “body bus,” and high-bandwidth wireless networking in a package that is nearly as light, comfortable, and unobtrusive as ordinary street clothing.

As we distribute intelligence across a wider range of devices, we are experiencing pervasive computing, also called ubiquitous computing. We are taking computers out of stand-alone boxes to which we are tied and putting them into ordinary things, in everyday objects around us. These new things, because they are smart, have a sense of self-awareness and are able to take care of themselves. When we embed intelligence into a device, we create an interesting new opportunity for business. That device has to have a reason for being, and it has to have a reason to continue evolving so that you will spend more money a and time on it. To address this challenge, device manufacturers are beginning to bundle content and applications with their products. The result is smart refrigerators, smart washing machines, smart ovens, smart cabinets, smart furniture, smart beds, smart televisions, smart toothbrushes, and an endless list of other smart devices.

Another form of application that will be increasingly important is in the realm of streaming media. A great focus is put on the real-time delivery of information, as in entertainment, education, training, customer presentations, IPO trade shows, and telemedicine consultations.

Because of the pervasive nature of information and communication technologies and the services that derive from them, coupled with the large prizes to be won, the telecommunications sector is subjected to a lot of attention from policymakers. Particularly over the past 20 years or so, telecommunications policy and regulation have been prominent on the agendas of governments around the world. This reflects the global trend toward liberalization, including, in many countries, privatization of the former monopoly telcos. However, interest from policymakers in telecommunications goes much deeper than this. A great deal of this interest stems from the extended reach and wide impact that information and communication technologies have.

In case that a message is desired to be transmitted via a telephone line when a receiver is absent, a private answering machine has been used to record and reproduce the message for the receiver. Alternatively, a voice messaging service has been provided for the purpose by a communications service provider using a host computer. In such systems, however, the information is output by a speaker in a telephone handset or in other devices having a speaker. Accordingly, the type of the transmitted information is restricted to voice signals, and information in a form of text or graphics cannot be received. Also, a deaf person cannot use such devices.

By using an electronic mail (e-mail) service, one can store a message in a host computer of a service provider so that the message is read by a receiver. However, a person who wants to use the e-mail service needs to be equipped with a computer. Furthermore, a typical e-mail service cannot transfer voice information easily.

Recently, a pager which can display information other than telephone numbers is being commercialized. However, such a pager can display only a small amount of text information. Thus, the information cannot be received effectively by such a pager when the information is in the form of voice or graphics or when the amount of information is large.

Some television receivers having a capability of receiving teletext information can receive information on stock quotes or commodity information. However, in such a television, the same information is transmitted to everyone who has a similarly equipped television, and a private message (i.e., directed to a particular recipient) cannot be received.

No doubt mobile phones now have introduced a physical reality into the world of electronic communications. From simple distant hearing devices, these are growing into form of digital house having numerous sort of electronic intelligence and capabilities integrated. These are no more in luxurious items instead part of daily life from home to managing jobs. The invention exposes some general advantages mentioned as below:

Targeted Advertisement

TV Channels can know the interest of people thus improving their services by presenting the programs according to interest of people

Telecommunication companies will gather revenue

Mobile sales will be increased

New market for manufacturers of electronic devices

Research organizations can take benefit of data

Removal of manual process of adjustment of multimedia hardware

Users need not to know at what channel and frequency a specific program is available thus decreasing the inconvenience of users

Non technical users even can use multimedia more effectively

Availability of certain media programs can be known immediately

### BRIEF SUMMARY OF THE INVENTION

The setup comprises mobile phone, media to receive broadcasting, a decoder, hardware component and hardware to receive signals. The mobile phone is connected to decoder and decoder is connected to another hardware component that will set the frequency of apparatus responsible for receiving signals. The user sends message through mobile phone to telecommunication network server. The message comprises the unique id available in multimedia directory. The message is received at server and decoded. The unique id of multimedia is extracted.

After processing, server sends message to caller mobile phone. The message is received at caller's mobile and again there is decoder to decode this message. The message is decoded and instructions are passed to hardware component to invoke specific action on the media responsible for receiving signals.

### BRIEF DESCRIPTION OF THE DRAWINGS

Sheet 1:

The flowchart shows the simple process of invention setup and execution.

### DETAILED DESCRIPTION OF THE INVENTION

The invention is related with telecommunications network in general. A directory exists on telecommunication server where all the multimedia programs are mapped. Though information regarding mapping may be irrelevant with this patent application yet to mention mapping may be residing in a RDBMS where a specific main mapping table may have columns multimedia item's unique id, multimedia item name and frequency at which this program can be received at the receiving media, item status, action to be taken and so on.

The status column may have different values but not limited to Exists, Not Exists, Near Future, Not Available, Legal Issue, Age Verification Required and so on. These values off course are customizable according to required reasons or restrictions. Similarly Action to be taken column may guide what action to be taken depending on the values in item status column. Specifically this column may have values like “Send” or “Abort”.

The invention necessarily comprises mobile phone, media to receive multimedia items from telecommunication server such as television, radio . . . etc, media responsible to receive signals such as satellite dish, Antenna . . . etc, a special device or software program for decoding purposes and hardware component to interact with media responsible for receiving signal. Anyhow the schematic structure of mobile, decoder and hardware component may be different. For example, a decoder may already inside mobile phone in form of hardware or software or it can be attached with special hardware component or it can be a standalone device itself.

The invention setup is simple and straight. Mobile phone is connected to decoder whereas decoder is connected to hardware component responsible of interaction and hardware component is again connected with both mobile phone and media responsible for receiving signals. Again the schematic structure of mobile, decoder and hardware component may be different. For example, a decoder may already inside mobile phone in form of hardware or software or it can be attached with special hardware component or it can be a standalone device itself.

The user who is using the said setup sends message to telecommunication server. The message format may have different structure and size. A simple message may comprise destination phone-number and multimedia required item. The message may comprise separators to identify the items in message. For instance a simple message may be “PN#MN” where PN is the telephone number where message needs to be sent that is necessarily the number so that messages can be received at telecommunication server and MN is the multimedia item required. For example a valid message may be “333#F12345” The message may also comprise password if some channel is protected through passwords and receiver can not be fixed to the required channel. The user is also able to send voice messages so that a remote operator may help the user in order to fix the receiver according to user's wish.

The message sent by the user is received at telecommunication server. The message is broken into parts by separators. Through parts, required multimedia item number is identified. This multimedia item number is searched through the multimedia directory and frequency is identified into the mapped directory table. Now there may be different cases such as required multimedia item number exists in the directory or this number does not exist or the requested multimedia program is not available or program will be available In near future or request is denied to some legal issues or so.

Depending on the value in item status column if it is “Send” the user is sent back the message in appropriate format with the frequency of required item. This frequency may be encrypted or coded according to invention setup. The message sent back by the server may also include the additional messages retrieved from said RDBMS. If the required action is not “Send” then user is still sent back with messages comprising messages retrieved from said RDBMS according to the failure reason such as “Your required program is not available” or no channel is available to serve you . . . etc.

When the message is received by the decoder attached with hardware component responsible of interaction, the intelligent decoder decodes the message. The message is broken into parts and decrypted. From decrypted message frequency of desired item is identified. This frequency identified from the broken message is passed to another hardware component that is attached with media such as satellite dish. The hardware component is quite intelligent to know the current position and frequency of the satellite dish or attached media. The hardware component moves or adjusts the frequency of the media accordingly automatically.

There may be cases when mobile phone is not connected with the said media that may be called as mobile phone is offline. When mobile phone comes online i.e. as soon as mobile phone is connected with the decoder, it may execute the latest frequency operation sent by the telecommunication server and discards other operations. The invention may become even more smarter if one part of this implemented in mobile phones. With this system, users will be able to execute the desired uncompleted operations.

The decoder is also intelligent enough to track the latest operation executed by the decoder and pending messages. The decoder always passes the message to hardware component responsible for interaction with media to receive signals. Anyhow details of this mechanism is out of the scope of this invention.

Here the further clarification is provided with a simple setup scenario. Below is the listings of unique ID and multimedia programs and required channel numbers along with their frequency. This listing is shown on the next page.

| Unique ID | Item Name | Status | Action | Message |
|---|---|---|---|---|
| F000001 | Film-1 | Exists | Send | |
| F000002 | Film-2 | Exists | Send | |
| F000003 | Film-3 | Not Exists | Abort | Your requested Film3 |
| | | | | is not available. |
| F000004 | Film-4 | Legal | Abort | This program is not |
| | | | | available. |
| S000001 | Sports1 | Exists | Send | |
| S000002 | Sports2 | Exists | Send | |
| S000003 | Sports3 | Exists | Send | |
| S000004 | Sports4 | Exists | Send | |
| S000005 | Sports5 | Exists | Send | |
| E000001 | E1 | Exists | Send | |
| E000002 | E2 | Exists | Send | |

Lets consider the phone number of telecommunication server is 333. The user sends message “333# F000002”. The message is received at server and a message is sent back to user mobile having the frequency of desired item “F000002”. The mobile phone of user is connected with decoder. The decoder decodes the message, extracts change information and passes this information to hardware component responsible for media interaction. The device adjusts the media according to received information from the decoder.

Let's consider another example where user sends message “333# F000003” to server. The users again receives message from server that “Your requested Film3 is not available”. The decoder does not pass this message to hardware component because no action is required as “Action” column has indication that operation should be aborted.

Let's consider another example where user sends message “333# F12003” to server. The users again receives message from server that “This program is not available” as this number is not present in the multimedia directory. Again this condition can also be mentioned and action can be taken accordingly.

What I claim as my invention is:

1. A system to fixing the user's media receiver according to program user wants to view or listen depending upon the availability of the said program comprises:
a storing means for storing at least one multimedia program;
a media to store messages received from users;
a process to validate messages received from users;
a message builder to build message according to required format;
a controller for reading frequency, channel and related information related to requested multimedia stored in said storing means to send an information message to user's mobile or telephone;
a controller or device connected to mobile or telephone for decoding the message received and extracting frequency and related information and passes extracted information to another controller or device to adjust the receiver according to the received information;
a controller or device for adjusting the receiver according to the information received from another device;

2. A controller for reading frequency step according to claim 1, wherein the said controller extracts the required multimedia program number from the message received from user;

3. A controller according to claim 2, wherein the controller sends the message parameters to message builder and message builder sends the built message back to the controller

4. A controller according to claim 3, wherein the controller sends the message back to user's telephone

5. A controller or device connected to mobile or telephone step in claim 1 wherein the said controller or device may exist separate or it may be built inside the mobile or receiver

6. A controller or device connected to mobile or telephone step in claim 1 wherein the said controller or device decodes the message and passes this information to another controller responsible for receiver adjustments if received message has instructions to adjust the receiver

7. A controller or device connected to mobile or telephone step wherein controller can identify the messages which already have been received and only passes the new messages to another controller when the said controller is connected to mobile phone

8. A controller or device for adjusting the receiver step in claim 1 wherein the said controller restores the original state of the receiver if current operation is failed or can not continued
